(19) United States
(12) Patent Application Publication
(10) Pub. No.: US 2025/0132090 A1
(43) Pub. Date: Apr. 24, 2025

(54) METHOD FOR MANUFACTURING AN ELECTRONIC DEVICE WITH AN INTEGRATED PERMANENT MAGNET AND ELECTRONIC DEVICE WITH AN INTEGRATED PERMANENT MAGNET

(71) Applicant: Fraunhofer-Gesellschaft zur Förderung der angewandten Forschung e.V., München (DE)

(72) Inventors: Thomas LISEC, Itzehoe (DE); Björn GOJDKA, Itzehoe (DE)

(73) Assignee: Fraunhofer-Gesellschaft zur Förderung der angewandten Forschung e.V., München (DE)

(21) Appl. No.: 18/919,458

(22) Filed: Oct. 18, 2024

(30) Foreign Application Priority Data
Oct. 18, 2023 (DE) 10 2023 210 246.3

(51) Int. Cl. H01F 41/02; H01F 7/02

(52) U.S. Cl. CPC H01F 41/0253; H01F 7/021

(57) ABSTRACT

A method for manufacturing an electronic device with an integrated permanent magnet for providing a magnetic field is disclosed. The method includes providing a first substrate and structuring a cavity into a first substrate surface. The permanent magnet integrated within the cavity is generated by introducing loose powder including magnetic material into the cavity and by subsequently agglomerating the powder to a mechanically firm magnetic body structure by means of atomic layer deposition. The method further includes providing a second substrate, wherein at least one electronic component is arranged on a first substrate surface of the second substrate, and aligning the two substrates with respect to each other so that the permanent magnet integrated into the first substrate functionally interacts with the electronic component arranged on the second substrate and provides a magnetic field for the electronic component. The two substrates are bonded by means of a bonding layer attached between the two substrates.

### CROSS-REFERENCE TO RELATED APPLICATION

This application claims priority from German Patent Application No. DE 10 2023 210 246.3, which was filed on Oct. 18, 2023, and is incorporated herein in its entirety by reference.

The innovative concept described herein concerns a method for manufacturing an electronic device with at least one permanent magnet integrated on the substrate level or plane, wherein the permanent magnet integrated into the substrate functionally interacts with an electronic component.

### BACKGROUND OF THE INVENTION

Magnetic fields are used in almost all parts of technology. For example, permanent magnets are used in combination with Hall sensors or XMR sensors for the detection of movement, speed, or position in equipment and devices.

A typical arrangement is the so-called back-bias configuration, wherein a magnetic supporting field is generated by a magnet on the rear side of a chip with Hall sensors perpendicular to the substrate plane. In AMR sensors, on the other hand, magnetic supporting fields are required in the substrate plane so as to adjust the direction of the magnetization of the sensor layer. In this connection, reference is made to an in-plane bias or a magnetic supporting field in the substrate plane.

Other electronic systems also require local magnetic fields, e.g. in connection with quantum computers or ion traps, when ions are manipulated by electric or magnetic fields.

Currently, conventionally manufactured permanent magnets mounted in a hybrid way together with the electronic device to form an assembly are used to generate static magnetic fields. To miniaturize such assemblies, it would be advantageous to position the smallest magnets or arrays of smallest magnets in a precise way already on the substrate level so as to avoid adjustment errors in pick-and-place mounting. In addition, freely selecting the shapes of the magnets would be of advantage to locally adjust the magnetic field particularly precisely.

The present description discloses a possibility to precisely connect micromagnets generated in a substrate with electronic devices on the substrate level to form an assembly.

### SUMMARY

An embodiment may have a method for manufacturing an electronic device with an integrated permanent magnet for providing a magnetic field, the method comprising: providing a first substrate and structuring a cavity into a first substrate surface, generating the integrated permanent magnet within the cavity by introducing loose powder comprising magnetic material into the cavity and by subsequently agglomerating the powder to a mechanically firm magnetic body structure by means of atomic layer deposition, providing a second substrate, wherein at least one electronic component is arranged on a first substrate surface of the second substrate, aligning the two substrates with respect to each other so that the permanent magnet integrated into the first substrate functionally interacts with the electronic component arranged on the second substrate and provides a magnetic field for the electronic component, and bonding the two substrates by means of a bonding layer attached between the two substrates.

Another embodiment may have an electronic device with an integrated permanent magnet for providing a magnetic field, wherein the electronic device comprises: a first substrate with a cavity extending from a first substrate surface towards the opposite second substrate surface, wherein a mechanically firm porous permanent magnet generated by means of agglomerating loose powder comprising magnetic material is integrated within the cavity, a second substrate, wherein at least one electronic component is arranged on a first substrate surface of the second substrate, wherein the two substrates are bonded by means of a bonding layer attached between the two substrates, and wherein the two substrates are aligned with respect to each other such that the permanent magnet integrated into the first substrate functionally interacts with the electronic component arranged on the second substrate and provides a magnetic field for the electronic component.

The inventive method, inter alia, includes providing a first substrate and structuring a cavity into a first substrate surface. A further step includes generating an integrated permanent magnet within the cavity by introducing loose powder comprising magnetic material into the cavity and subsequently agglomerating the powder to a mechanically firm magnetic body structure by means of atomic layer deposition. A further step includes providing a second substrate, wherein at least one electronic component is arranged on a first substrate surface of the second substrate. A further step includes aligning the two substrates with respect to each other so that the permanent magnet integrated into the first substrate functionally interacts with the electronic component arranged on the second substrate and provides a magnetic field for the electronic component. A further step includes bonding the two substrates by means of a bonding layer attached between the two substrates.

The inventive method makes it possible to combine any electronic components of an electronic device in a simple way on the substrate level with permanent magnets functionally interacting with the respective electronic component. For example, the permanent magnet integrated into the first substrate may provide a magnetic supporting field for the electronic component arranged on the second substrate. For example, the electronic component may be a micro-electronic circuit, such as a magnetic sensor circuit. For example, it may be a Hall sensor or a magnetoresistive xMR sensor. In addition, the inventive method makes it possible to realize very small and also comparably large distances between the magnets and the electronic component. The inventive method can be applied to any type of substrate with any electronic components. In addition, the inventive method makes it possible to three-dimensionally shape the magnetic field generated by the permanent magnet with respect to its shape, strength and its gradients across a wide range and with high spatial precision.

By using the inventive method, accordingly, an electronic device with an integrated permanent magnet for providing a magnetic field may be manufactured, wherein the electronic device, inter alia, comprises a first substrate with a cavity extending from a first substrate surface towards the opposite second substrate surface. A mechanically firm porous permanent magnet generated by means of agglomerating loose powder comprising magnetic material is integrated within the cavity. Furthermore, the electronic device includes a second substrate, wherein at least one electronic component is arranged on a first substrate surface of the second substrate, and wherein the two substrates are bonded by means of a bonding layer attached between the two substrates. Here, the two substrates are aligned with respect to each other such that the permanent magnet integrated into the first substrate functionally interacts with the electronic component arranged on the second substrate and provides a magnetic field for the electronic component.

### BRIEF DESCRIPTION OF THE DRAWINGS

Embodiments of the present invention will be detailed subsequently referring to the appended drawings, in which:

FIG. 1A shows a schematic lateral view of an angular sensor system with an encoder wheel according to the conventional technology,

FIG. 1B shows a schematic lateral view of an angular sensor system with a soft-magnetic wheel and a back-bias magnet according to the conventional technology,

FIG. 1C shows a schematic sectional view of a housed angular sensor system according to the conventional technology,

FIGS. 2A-F show a schematic sequence of method steps for manufacturing an inventive electronic device according to an embodiment,

FIG. 3A shows a schematic lateral sectional view of a substrate to illustrate a method step for generating cavities in a first substrate according to an embodiment,

FIG. 3B shows a schematic lateral sectional view of a substrate to illustrate an alternative method step for generating cavities in a first substrate according to an alternative embodiment,

FIGS. 4A-4D show different embodiments of an inventive electronic device, and

FIGS. 5A-C show further different embodiments of an inventive electronic device with different magnet arrangements.

### DETAILED DESCRIPTION OF THE INVENTION

In the following, embodiments are described in more detail with reference to the drawings, wherein elements with the same or similar function are provided with the same reference numerals.

Method steps shown or described in the context of the present disclosure may be performed in any other sequence than the one that is shown or described. In addition, method steps concerning a certain feature of an apparatus are interchangeable with said feature of the apparatus, and vice versa.

For simplicity reasons, the subsequently described embodiments are described purely exemplarily in the form of back-bias configurations for magnetic field sensors, since they are representative for all other applications. Other embodiments in which electronic components functionally interact with static magnetic fields generated by permanent 10 magnets are also included. For example, this concerns ion traps for quantum computers and the like. To this end, e.g. three-dimensionally shaped magnetic fields with certain gradients are required.

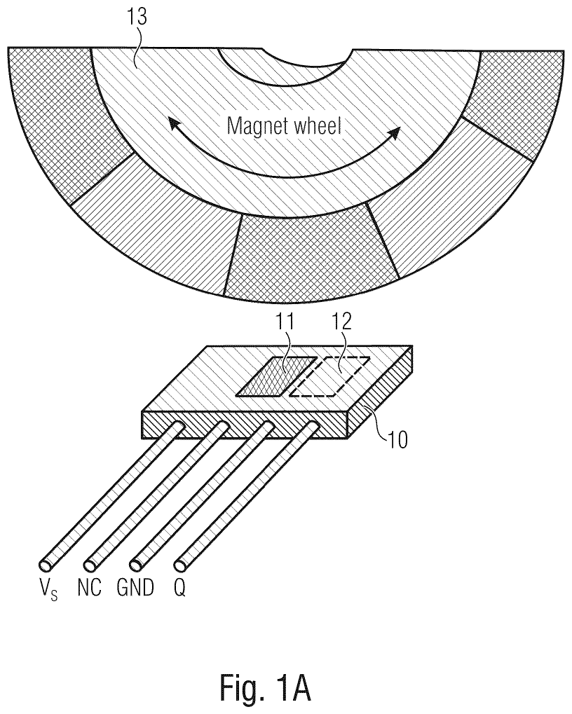

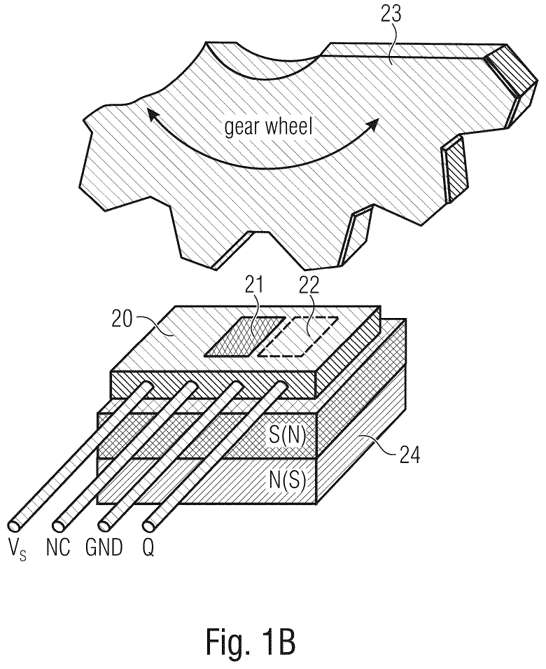

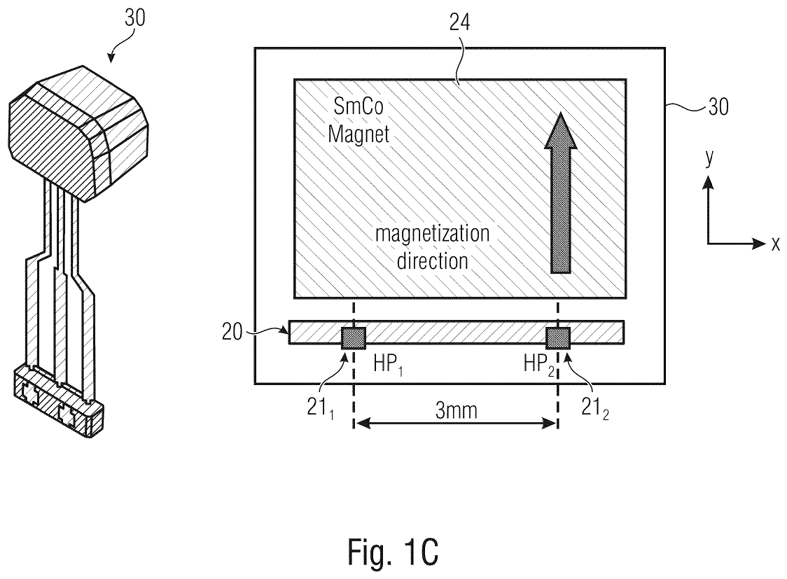

As an introduction in this regard, FIGS. 1A to 1C show conventional sensor arrangements 15 using static magnetic fields to capture a rotational angle or a current position of a transmitter wheel.

In this case, FIG. 1A shows the use of conventional magnetic field sensors to monitor a rotational movement with a magnetized pole wheel. A Hall sensor 11 may be provided on a substate 10 together with a corresponding circuit 12. An encoder wheel 13 (pole wheel) with oppositely magnetized pole fields may be arranged opposite this substrate 10, enabling a precise determination of axial positions, rotational angles, and rotational speeds. In this case, the magnets are distributed across the circumference of the pole wheel 13, wherein the Hall sensor 11 detects the magnetic fields with alternating polarization.

FIG. 1B shows an alternative variation of conventional magnetic field sensors with back-bias magnets. Similarly, a Hall sensor 21 is arranged together with a corresponding circuit 22 on a mutual substrate 20. In this case, however, a Hall sensor 21 penetrated by the supporting field of a back-bias magnet 24 is used. In the case of such a sensor 21 with a back-bias 24, 30 instead of the pole wheel 13, a (soft-magnetic) tooth wheel 23 located in the transmission is monitored. The movement of the teeth causes a modulation (distortion) of the field provided by the back-bias magnet 24, with said field being detected by the Hall sensor 21.

FIG. 1C shows a package 30 having arranged therein such a Hall sensor 21 with an 35 integrated back-bias magnet 24. On the right side, FIG. 1C shows a schematic cross section of the package 30. It shows that the magnet 24 uses most of the space of the housing 30.

Two active sensor faces 211, 212 whose magnetic field strength should be in the same range are arranged on the substrate 20 in a distance of 2-3 mm. The back-bias magnet 24 has to be sufficiently wide so as to be able to compensate assembly tolerances by means of subsequent calibration. Since the field strength depends on the aspect ratio of the magnet 24, a certain minimum height is required in the case of a vertical magnetization so as to provide a certain magnetic flux density in the area of the sensor faces 211, 212 or the tooth wheel 23. A large magnet 24 is of advantage in order to be able to use sensor circuits that are as cost-efficient as possible, to minimize the influence of external interfering fields and to enable a detection distance that is as large as possible. Electronic devices as shown in FIG. 1C are broadly used in the automotive industry.

For devices and systems that may consist of particularly compact mechanisms and electronic assemblies, an electronic device according to FIG. 1C may not only lead to problems regarding space, but also to an impairment of functions, e.g. by cross-talk of the magnetic fields of the back-bias magnets 24 with respect to neighboring electronic components. Furthermore, depending on the application, very precise magnetic field geometries whose field strengths have to be defined spatially in the range of micrometers may be required. Accordingly, the magnet 24 has to be substantially miniaturized. Serial, fine-mechanic manufacturing of smallest magnets with complex shapes made of SmCo or NdFeB and their precise adjustment with respect to electronic devices causes significant additional costs or is not possible at all. In such cases, it is desired to integrate micromagnets with the electronic devices on the substrate level, i.e. parallel for many devices at the same time.

The proposed invention provides a solution for this. Accordingly, a method for manufacturing an electronic device with an integrated permanent magnet configured to generate a magnetic field for the electromagnetic device is proposed.

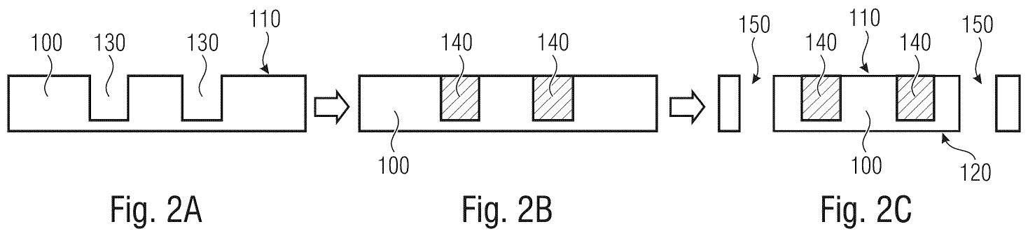

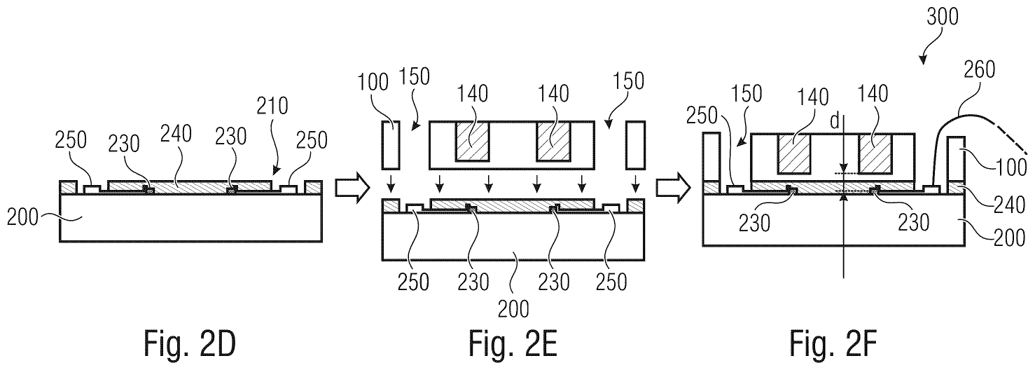

FIGS. 2A to 2F show individual method steps of the inventive manufacturing method. The inventive method may be carried out both on the wafer level as well as on the chip level. In the first case, the subsequently described substrates 100, 200 may be wafers. In the latter case, the subsequently described substrates 100, 200 may be individual chips.

FIG. 2A shows a method step in which a first substrate 100 is initially provided. For example, the first substrate 100 may include silicon, glass, metal, ceramic or plastic, or consist thereof. At least one cavity 130 is structured into a first substrate surface 110 of the first substrate 100. The first substrate surface 110 may be, as exemplary illustrated in FIG. 2A, the top side of the first substrate 100. However, it would also be conceivable that the same were the opposite bottom side of the first substate 100. Corresponding embodiments are subsequently described in more detail.

FIG. 2B shows a further method step. Here, an integrated permanent magnet 140 is generated in the cavities 130. According to the invention, the permanent magnet 140 is manufactured by filling a loose powder comprising a magnetic material into the cavity 140. This dry loose powder is subsequently agglomerated to a mechanically firm magnetic body structure by means of atomic layer deposition (ALD).

A method for generating integrated micromagnets 140 by using atomic layer deposition developed by the applicant, in the following referred to as PowderMEMS method, is described in EP 2 670 880 B1, whose content is hereby fully incorporated by reference. In this case, cavities in a substrate are filled with loose powder. Subsequently, the loose powder is agglomerated by means of atomic layer deposition (ALD) to mechanically firm microstructures. Good ferromagnetic properties could be proven for such 3D microstructures, manufactured from NdFeB powder on substrates of silicon. In addition, the micromagnets manufactured by using this method are structurally simple and can be clearly distinguished from other permanent magnets manufactured by using other methods. For example, the micromagnets manufactured by the PowderMEMS method comprise a very hard and simultaneously porose structure.

FIG. 2C shows an optional method step. In this case, at least one through hole 150 is structured into the first substrate 100, wherein the through hole 150 fully extends through the substrate 100 between the first substrate surface 110 (e.g. top side) and an opposite second substrate surface 120 (e.g. bottom side). The through hole 150 provides an access for a bonding wire that may be optionally added in a later method step. For example, the through hole 150 may be generated by using appropriate etching methods, such as DRIE (Deep Reactive Ion Etching).

FIG. 2D shows a further method step. Here, a second substrate 200 is provided, wherein at least one electronic component 230 is arranged on a first substrate surface 210 of the second substrate 200. For example, the electronic component 230 may be an electronic (integrated) circuit, a sensor element, a discrete electronic device, and the like. The electronic component 230 is part of the electronic device 300 that may be manufactured by using the inventive method (FIG. 2F).

The first substrate surface 210 of the second substrate 200 may be, as exemplary illustrated in FIG. 2D, the top side of the second substrate 200. However, it would also be conceivable that the same were the opposite bottom side of the second substrate 200. Corresponding embodiments are subsequently described in more detail.

In addition, a bonding layer 240 is arranged on the first substrate surface 210 (e.g. top side). The bonding layer 240 is structured such that an electrical contact pad 250, for contacting the electronic component 230, arranged on the first substrate surface 210 (e.g. topside) is left free so that the contact pad 250 remains uncovered by the bonding layer 240. As can be seen in FIG. 2D, the contact pad 250 and the electronic component 230 are electrically connected.

FIG. 2E shows a further method step. Here, the two substrates 100, 200 are aligned with respect to each other such that at least one of the permanent magnets 140 integrated into the first substrate 100 functionally interacts with at least one of the electronic components 230 arranged on the second substrate 200. This is understood such that the permanent magnet 140 generates a static magnetic field that is functionally used by the electronic component 230. For example, this may be a back-bias magnet 140 providing a magnetic supporting field for a magnetic sensor 230 or for quantum ion traps 230.

For example, the two substrates 100, 200 may be aligned with respect to each other such that the permanent magnet 140 integrated into the first substrate 100 is positioned directly opposite the electronic component 230 arranged on the second substrate 200, as exemplary illustrated in FIG. 2E. However, a lateral offset between the permanent magnet 140 integrated into the first substrate 100 and the electronic component 230 arranged on the second substrate 200 is also conceivable, as will be discussed subsequently in alternative embodiments. The relative positioning between the permanent magnet 140 integrated into to first substrate 100 and the electronic component 230 arranged on the second substrate 200 may depend, inter alia, on the shape and/or field strength of the magnetic field generated by the permanent magnet 140 integrated into the first substrate 100.

Alternatively or additionally, the two substrates 100, 200 may be aligned with respect to each other such that the above-described through hole 150 in the first substrate 100 is directly opposite the contact pad 250, on the second substrate 200, left free from the bonding layer 140. This may enable an access to the contact pad 250 through the first substrate 100 from the outside.

FIG. 2F shows a further method step. Here, the two substrates 100, 200 are connected, or bonded, to each other by means of the bonding layer 240 attached between the two substrates 100, 200. To this end, the two substrates 100, 200 are brought into contact after being aligned and are bonded at a certain temperature and a certain contact pressure. Thus, a substrate stack containing the first and the second substrate 100, 200 is obtained. In the case of individual wafers 100, 200, a wafer stack is obtained, for example.

Thus, following the bonding of the two substrates 100, 200, an inventive electronic device 300 is obtained. The electronic device 300 comprises a substrate stack (e.g. a wafer stack) containing the first and the second substrates 100, 200. In turn, the substrate stack 100, 200 comprises at least one integrated electronic circuit 230 and at least one integrated permanent magnet 140 functionally interacting with the electronic circuit 230.

To electrically contact the electronic component 300, an electric conductor 260, e.g. in the form of a bonding wire, may be led through the through hole 150 provided in the first substrate 100. One end of the bonding wire 260 may electrically contact the contact pad 250 arranged on the second substrate 200. The opposite ends of the bonding wire 260 may be coupled to a (non-illustrated) electronic circuit, such as a microcontroller, for example. Thus, the inventive electric device 300 may be electrically contacted with relatively little effort by means of wire bonding.

Alternatively to the above-discussed through hole 150, a vertical through substrate via (TSV) may be generated in the first substrate 100. If the first substrate 100 is a silicon substrate, the vertical through substrate via may be configured in the form of a through silicon via. In this case, the through substrate via could fully extend through the first substrate 100 between the first substrate surface 110 (e.g. top side) and the opposite second substrate surface 120 (e.g. bottom side), wherein the through substrate via electrically contacts the uncovered contact pad 250 so that the contact pad 250 can be contacted from the outside through the first substrate 100. That is, instead of air, an electrically conductive, e.g. metal, filling could be located in the through hole 150.

In order to be able to connect, by means of bonding on the substrate level, the first substrate 100 with the micromagnets 140 integrated therein and the second substrate 200 having arranged thereon the electronic devices 230, at least one of the two substrates 100, 200 should be provided with an appropriate structured bonding layer 240, e.g. made of polymers, metals or glass frit.

According to a conceivable embodiment, the step of bonding may include that the two substrates 100, 200 are bonded to each other by using a polymer-based bonding method at temperatures of 200° C. or less. For example, polymer-based bonding guarantees good durability and may be carried out at particularly low temperatures, such as at below 200° C. or even at below 100° C. However, the connection is not hermetically sealed and may degrade at higher temperatures, e.g. above 200° C.

According to an alternative embodiment, the step of bonding may include that the two substrates 100, 200 are bonded to each other by using a glass frit or a metal solder bonding method at temperatures of 450° C. and less. Glass frit bonding requires temperatures of between 250° C. and 450° C. and results in a mechanically firm, very durable and hermetically sealed connection.

As initially mentioned, the PowderMEMS method developed by the applicant may be used for generating the microstructure permanent magnets 140. A significant advantage of the PowderMEMS method is its BEOL (Back End of Line) compatibility, enabling post-processing of the micromagnets 140, i.e. they may be generated prior to, during, or after manufacturing of any electronic component 230. In addition, the signal-noise-ratio may be increased by multiple times via shape optimization of the integrated micromagnets 140.

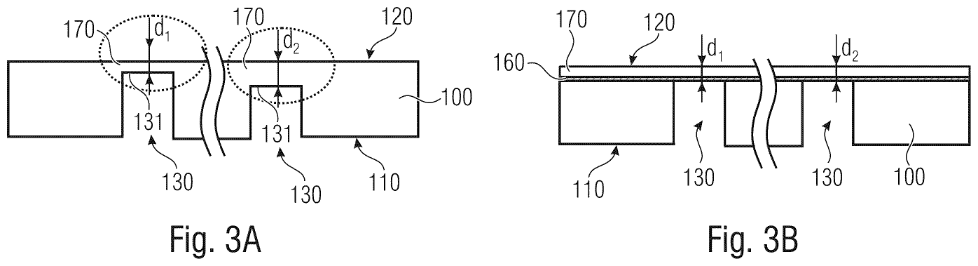

FIGS. 3A and 3B show different possibilities to generate the cavity 130 in the first substrate 100, wherein the microstructure permanent magnets 140 are subsequently generated.

In principle, the cavity 130 may be generated in the first substrate 100 by using an etching process, such as DRIE (Deep Reactive Ion Etching). Here, starting from the first substrate surface 110 (e.g. top side), etching is carried out essentially vertically (e.g. perpendicular to the substrate plane) towards the opposite second substrate surface 120 (e.g. bottom side).

The etching process is temporally controlled such that the etching process is stopped prior to reaching the second substrate surface 120 (e.g. bottom side) so that substrate material 170 (cf. circle in FIG. 3A) remains between the second substrate surface 120 (e.g. bottom side) and the bottom 131 of the cavity 130 with a specified thickness d₁, d₂.

When generating the cavities 130 in the first substrate 100 by means of DRIE on the wafer level, due to etching rate inhomogeneities, it might occur that deeper cavities 130 are created in the centre of the first substrate or wafer 100 than at the outer periphery or edge of the substrate 100. As schematically illustrated in FIG. 3A, the remaining thickness di of the substrate 100 may be significantly smaller in the centre of the substrate 100 than the remaining thickness d₂ in the lateral outer edge region. This thickness variation d₁<d₂ may cause deviations of the properties of the electronic devices 230 arranged on the second substrate 200, such as a bias-caused offset in the case of magnetic field sensors 230.

However, the thickness variation d₁<d₂ may be minimized by means of an etch stop layer 160 buried in the first substrate 100, as schematically illustrated in FIG. 3B. In this case, etching would be carried out through the substrate 100, starting from the first substrate surface 110 (e.g. top side) essentially vertically (i.e., perpendicular to the substrate plane) towards the second substrate surface 120 (e.g. bottom side) until reaching the etch stop layer 160 so that substrate material 170 having a specified thickness would remain between the second substrate surface 120 (e.g. bottom side) and the etch stop layer 160.

Together with the etch stop layer 160, the remaining substrate material 170 comprises a remaining thickness d₁, d₂. As can be seen, the etch stop layer 160 causes the remaining thickness d₁, d₂ to be essentially equal in all regions of a first substrate or wafer 100, i.e. d₁=d₂. Thus, the previously described thickness variation d₁<d₂ resulting due to the possible etching rate inhomogeneities may be compensated. That is, in the case of a buried etch stop layer 160, the etching rate variation is of no significance since the DRIE process stops on the buried etch stop layer 160 even in case of longer etching times.

For example, the substrate material 170 remaining on the etch stop layer 160 may be a functional silicon layer, or comprise such a functional silicon layer. This may be a monocrystalline silicon, as is the case in so-called SOI wafers (silicon on insulator), or it may be a polysilicon layer deposited in an epitaxial reactor. The substrate material 170 remaining on the etch stop layer 160 may have a thickness of between 1 μm and 100 μm.

For example, the etch stop layer 160 itself may consist of silicon dioxide (SiO₂) and/or it may have a thickness of up to 1 μm.

As mentioned initially, the cavities 130 are filled with magnetic material in the form of loose dry powder, and the powder is subsequently solidified by using an ALD method to become the rigid porous micromagnets 140. On the basis of the previously described remaining thickness d₁, d₂ of the remaining substrate material 170 between the bottom 131 of the cavity 130 and the second substrate surface 120 (e.g. bottom side), the distance a (FIG. 2F) between the respective permanent magnets 140 and the functionally associated electronic component 230 may be adjusted when bonding the two substrates 100, 200.

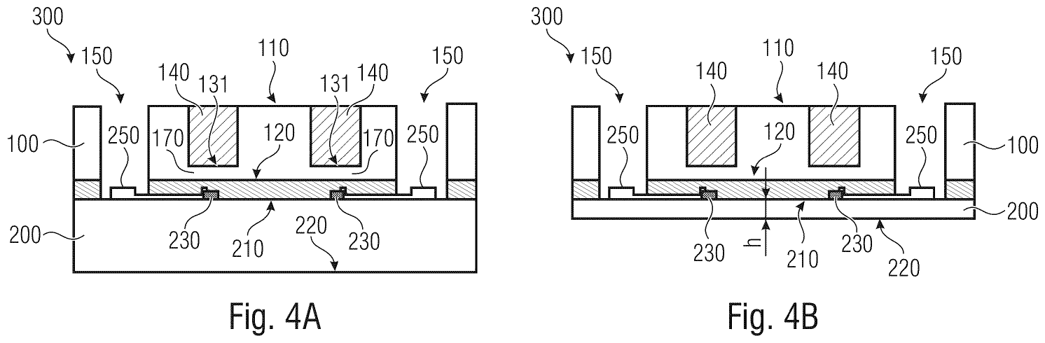

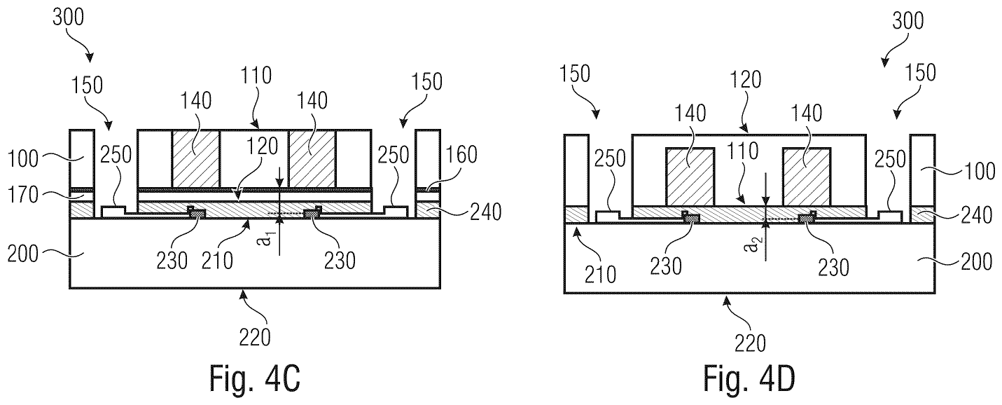

FIGS. 4A and 4B show a corresponding embodiment for this. The substrate stack 100, 200 illustrated in FIG. 4A essentially corresponds to the substrate stack 100, 200 discussed above with reference to FIG. 2F. In this case, the first substrate 100 is bonded to the second substrate 200 such that the second substrate surface 120 (e.g. bottom side) of the first substrate 100 is opposite the first substrate surface 210 (e.g. top side) of the second substrate 200. Thus, the previously mentioned remaining substrate material 170 is located between the permanent magnets 140 and the electronic components 230. Depending on the remaining thickness d₁, d₂ of the remaining substrate material 170 (cf. FIGS. 3A, 3B), including the possibly present etch stop layer 160, as well as the thickness of the bonding layer 240, the distance a (cf. FIG. 2F) between the permanent magnets 140 and the respective functionally associated electronic component 230 varies.

Optionally, in all embodiments described herewith, the second substrate surface 220 (e.g. bottom side or rear side) of the second substrate 200 may be back-thinned. Such an optional method step is shown in FIG. 4B. To this end, the second substrate 200, with the electronic component 230 arranged thereon, may be back-thinned by using corresponding standard methods of the semiconductor technology, such as grinding and polishing, to a remaining thickness h of between 10 μm and 300 μm. If the electronic component 230 is to be configured in the form of magnetic field sensors, back-thinning may be of particular advantage since the distance h between the sensor elements 230 and a transmitter object, such as a pole wheel, tooth wheel, encoder wheel, etc., located thereunder (and not illustrated herein), can be reduced significantly. In this way, particularly small transmitter objects, or arrangements of smallest transmitter objects, such as magnetic bar codes, may be detected or spatially resolved with a compact and at the same time cost efficient apparatus 300.

FIG. 4C shows a further embodiment of an inventive electronic device 300 that may be manufactured with the inventive method. Here, the first substrate 100 comprises, as previously described with reference to FIG. 3B, a buried etch stop layer 160. The two substrates 100, 200 are arranged such that the second substrate surface 120 (e.g. bottom side) of the first substrate 100 is again opposite the first substrate surface 210 (e.g. top side) of the second substrate 200. In this case, the distance a₁ between the permanent magnets 140 and the respective functionally associated electronic component 230 is determined by the sum of the thicknesses of the remaining substrate material 170 of the first substrate 100 including the thickness of the buried etch stop layer 160 and the thickness of the bonding layer 240.

In principle, it can be noted that between a micromagnet 140 and its respective functionally associated electronic component 230 there is a distance a determined by the remaining thickness of the remaining substrate material 170 of the first substrate 100 and the thickness of the bonding layer 240 as well as the thickness of the optionally buried etch stop layer 160.

FIG. 4D shows a further embodiment of an inventive electronic device 300 that can be manufactured with the inventive method. This embodiment shows how the previously mentioned distance a₂ between the permanent magnet 140 and the respective functionally associated electronic component 230 may be decreased.

In the previously described embodiments, the bonding layer 240 has been arranged between the second substrate surface 120 (e.g. bottom side) of the first substrate 100 and the first substrate surface 210 (e.g. top side) of the second substrate 200 so that the bonding layer 240 as well as the part of the first substrate 100 are located between the permanent magnet 140 integrated into the first substrate 100 and the electronic component 230 arranged on the second substrate 200. These parts of the first substrate 100 may be the substrate material 170 remaining when generating the cavities 130, including the possibly present buried etch stop layer 160, for example.

In the embodiment shown in FIG. 4D, however, the first substrate 100 is rotated by 180°. That is, the two substrates 100, 200 are bonded to each other such that the first substrate surface 110 (e.g. turned-around top side) of the first substrate 100 is opposite the first substrate surface 210 (e.g. top side) of the second substrate 220. Thus, the permanent magnets 140 are in direct contact with the bonding layer 240.

That is, the bonding layer 240 is here arranged between the first substrate surface 110 (e.g. turned-around top side) of the first substrate 100 and the first substrate surface 210 (e.g. top side) of the second substrate 200 so that only the bonding layer 240 is located between the permanent magnet 140 integrated into the first substrate 100 and the electronic component 230 arranged on the second substrate 200. By simply “turning around” the first substrate 100, the distance a₂ between the permanent magnet 140 integrated into the first substrate 100 and the electronic component 230 arranged on the second substrate 200 may be decreased compared to the previous embodiments.

In the embodiments shown in FIG. 4D, the first substrate 100 is bonded to the second substrate 200 with the buried micromagnets 140 facing downward. The distance a₂ between the individual micromagnets 140 and the respective functionally associated electronic component 230 is then defined by the thickness of the bonding layer 240.

In addition, it may be of advantage to arranged the first substrate 100 with the embedded magnets 140 below the second substrate 200 with the electronic devices 230 and to connect them by means of the bonding layer 240. That is, the two substrates 100, 200 are bonded such that the first substrate 100 is arranged opposite the second substrate surface 220 (e.g. bottom side) of the second substrate 200, wherein the bonding layer 240 is located between the first and the second substrates 100, 200.

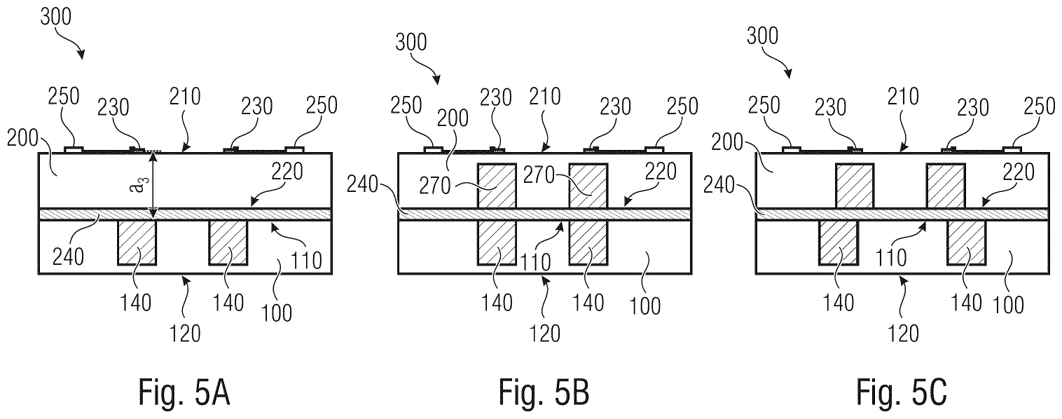

FIGS. 5A to 5C exemplarily show three possible arrangements, wherein the first substrate surface 110 (e.g. top side) of the first substrate 100 is opposite the second substrate surface 220 (e.g. bottom side) of the second substrate 200. However, it would also be conceivable that the second substrate surface 120 (e.g. bottom side) of the first substrate 100 were opposite the second substrate surface 220 (e.g. bottom side) of the second substrate 200.

In the embodiments shown in FIGS. 5A to 5C, the bonding layer 240 is arranged between the first substrate surface 110 (e.g. top side) of the first substrate 100 and the second substrate surface 220 (e.g. bottom side) of the second substrate 200 so that the bonding layer 240 and the complete second substrate 200 are located between the permanent magnet 140 integrated into the first substrate 100 and the electronic component 230 arranged on the second substrate 200.

The embodiment shown in FIG. 5A makes it possible to position the permanent magnets 140 integrated into the first substrate 100 with a larger distance a₃ to the electronic components 230 than in the previous embodiments. In this way, e.g. the strength and/or the gradient of the magnetic field may be set in a reasonably wide range.

FIG. 5B shows a further embodiment of an inventive electronic device 300 that can be manufactured with the inventive method. In this embodiment, the second substrate 200 also includes integrated permanent magnets 270 that may be generated in the same way as the permanent magnets 140 integrated into the first substrate 100. The permanent magnets 270 integrated into the second substrate 200 may be generated by using the PowderMEMS method, wherein a cavity is initially structured into the second substrate surface 220 (e.g. bottom side) of the second substrate 200, and wherein magnetic material is introduced into the cavity in the form of loose dry powder that is subsequently agglomerated by using atomic layer deposition to a mechanically firm magnetic body structure.

If the second substrate 200 is to comprise one or several integrated permanent magnets 270, the method of manufacturing the electronic device 300 described herein may also be applied without any problems. In this case, the step of aligning the two substrates 100, 200 may include that the permanent magnet 140 integrated into the first substrate 100 is positioned opposite the permanent magnet 270 integrated into the second substrate 200. FIG. 5B shows an embodiment in which the permanent magnets 140, 270 are positioned in the first and second substrates 100, 200 opposite each other and are aligned with each other so as to be flush. The permanent magnets 140 integrated into the first substrate 100 and the permanent magnets 270 integrated into the second substrate 200 may essentially comprise the same lateral dimensions.

FIG. 5C shows an alternative embodiment in which the permanent magnets 140, 270 integrated into the first and second substrates 100, 200 are each positioned opposite each other and are laterally offset (i.e. in the substrate plane). In the embodiment shown in FIG. 5C, the permanent magnets 140, 270 integrated into the first and second substrates 100, 200 have an overlap in a projection or top view. However, it would also be conceivable that the permanent magnets 140, 270 integrated into the first and second substrates 100, 200 did not have such an overlap. In this case, the permanent magnets 140, 270 would not be directly opposite each other (at least in portions).

In the embodiments shown in FIGS. 5B and 5C, integrated magnets 270 are also included in the second substrate 200 comprising the electronic components 230. By bonding the first substrate 100 to the permanent magnets 140 integrated therein, the effect of the permanent magnets 270 integrated into the second substrate 200 may be amplified. If the electronic components 230 are magnetic field sensors, for example, a stronger field may be provided in the area of the encoder object, so as to be able to better compensate stray fields or to enable monitoring of the transmitter object in a larger distance. In the embodiment according to FIG. 5C, the permanent magnets 140 integrated into the first substrate 100 and the permanent magnets 270 integrated into the second substrate 200 are integrated at different positions in the respective substrates 100, 200, broadening the possibilities of the three-dimensional shaping of the magnetic field. In this case, the permanent magnet 140 integrated into the first subset 100 and the permanent magnets 270 integrated into the second substrate 200 at least partially overlap, wherein a different fully overlap-free arrangement of the magnets 140, 270 would also be conceivable.

In summary, it can be noted that the invention proposed herein includes manufacturing magnetic 3D microstructures 140 on or in a separate substrate 100 made of silicon, glass, metal, ceramics or plastic. Subsequently, the first substrate 100 containing the micromagnets 140 is connected to the second substrate 200 containing the electronic components 230 by means of bonding on the wafer level.

Manufacturing the magnetic 3D micro structures 140 in the first substrate 100 follows the process described in FIGS. 2A to 2C. Cavities 130 that are subsequently filled with magnetic powder are generated in the first substrate 100. The magnetic powder is then agglomerated by means of ALD to become firm magnetic 3D micro structures (permanent magnets) 140 anchored in the cavities 130. Optionally, through holes 150 may be generated in the first substrate 100 at certain locations so as to enable contacting of the electric terminals (contact pads) 250 on the second substrate 200 after bonding on the wafer level. Alternatively, i.e. instead of the through holes 150, so-called through silicon vias (TSVs) may be integrated into the first substrate 100 so as to lead out the electric contacts 250 from their front side to their rear side.

Thus, the invention enables integration of magnetic supporting fields for electronic components 230, such as magnetic field sensors and quantum ion traps.

The above-described embodiments merely represent an illustration of the principles of the present invention. It is understood that other persons skilled in the art will appreciate modifications and variations of the arrangements and details described herein. This is why it is intended that the invention be limited only by the scope of the following claims rather than by the specific details that have been presented herein by means of the description and the discussion of the embodiments.

Even though some aspects have been described within the context of a device, it is understood that said aspects also represent a description of the corresponding method, so that a block or a structural component of a device is also to be understood as a corresponding method step or as a feature of a method step. By analogy therewith, aspects that have been described within the context of or as a method step also represent a description of a corresponding block or detail or feature of a corresponding device. Some or all of the method steps may be performed while using a hardware device, such as a microprocessor, a programmable computer or an electronic circuit. In some embodiments, some or several of the most important method steps may be performed by such a device.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. Method for manufacturing an electronic device with an integrated permanent magnet for providing a magnetic field, the method comprising:
providing a first substrate and structuring a cavity into a first substrate surface,
generating the integrated permanent magnet within the cavity by introducing loose powder comprising magnetic material into the cavity and by subsequently agglomerating the powder to a mechanically firm magnetic body structure by means of atomic layer deposition,
providing a second substrate, wherein at least one electronic component is arranged on a first substrate surface of the second substrate,
aligning the two substrates with respect to each other so that the permanent magnet integrated into the first substrate functionally interacts with the electronic component arranged on the second substrate and provides a magnetic field for the electronic component, and
bonding the two substrates by means of a bonding layer attached between the two substrates.

2. Method according to claim 1,
wherein the bonding layer is arranged on the first substrate surface of the second substrate, and the method further comprising:
structuring the bonding layer, wherein an electric contact pad for contacting the electronic component is left free so that the contact pad remains uncovered by the bonding layer.

3. Method according to claim 2, further comprising:
structuring a through hole into the first substrate, wherein the through hole extends fully through the first substrate between the first substrate surface and an opposite second substrate surface,
wherein aligning the two substrates comprises aligning the same with respect to each other such that the through hole is opposite the uncovered contact pad so that the contact pad is accessible from the outside through the first substrate, and
contacting the uncovered electric contact pad by means of a bonding wire guided through the through hole.

4. Method according to claim 2, further comprising:
generating a vertical through substrate via in the first substrate, wherein the through substrate via fully extends through the substrate between the first substrate surface and an opposite second substrate surface, and
wherein aligning the two substrates comprises aligning the same with respect to each other such that the through substrate via electrically contacts the uncovered contact pad so that the contact pad can be contacted from the outside through the first substrate.

5. Method according to claim 1,
wherein the cavity in the first substrate is generated by using an etching process,
wherein, starting from the first substrate surface, etching is carried out essentially perpendicular towards the opposite second substrate surface, and
wherein the etching process is controlled such that the etching process is stopped prior to reaching the second substrate surface so that substrate material remains between the second substrate surface and the bottom of the cavity with a specified thickness d₁, d₂.

6. Method according to claim 1,
wherein the cavity in the first substrate is generated by using an etching process,
wherein the first substrate comprises a buried etch stop layer, and
wherein, starting from the first substrate surface, etching is carried out essentially perpendicular towards the opposite second substrate surface until reaching the etch stop layer so that substrate material remains between the second substrate surface and the etch stop layer with a specified thickness.

7. Method according to claim 1,
wherein the bonding layer is arranged between the second substrate surface of the first substrate and the first substrate surface of the second substrate, so that the bonding layer and parts of the first substrate are located between the permanent magnet integrated into the first substrate and the electronic component arranged on the second substrate.

8. Method according to claim 1,
wherein the bonding layer is arranged between the first substrate surface of the first substrate and the first substrate surface of the second substrate so that only the bonding layer is located between the permanent magnet integrated into the first substrate and the electronic component arranged on the second substrate.

9. Method according to claim 1, further comprising:
back-thinning the second substrate surface of the second substrate.

10. Method according to claim 9,
wherein the second substrate is back-thinned to a remaining thickness h of between 10 μm and 300 μm.

11. Method according to claim 1,
wherein the bonding layer is arranged between the first substrate surface of the first substrate and the second substrate surface of the second substrate so that the bonding layer and the second substrate are located between the permanent magnet integrated into the first substrate and the electronic component arranged on the second substrate.

12. Method according to claim 1, further comprising:
structuring a cavity into the second substrate surface of the second substrate, and
generating an integrated permanent magnet within the cavity by introducing loose powder comprising magnetic material into the cavity and subsequently agglomerating the powder to a mechanically firm magnetic body structure by means of atomic layer deposition.

13. Method according to claim 12,
wherein aligning two substrates comprises positioning the permanent magnet integrated into the first substrate opposite the permanent magnet integrated into the second substrate.

14. Method according to claim 13,
wherein the permanent magnet integrated into the first substrate and the permanent magnet integrated into the second substrate are flush, or
wherein the permanent magnet integrated into the first substrate and the permanent magnet integrated into the second substrate comprise a lateral offset.

15. Method according to claim 1,
wherein bonding comprises bonding the two substrates to each other by using a polymer-based bonding method at temperatures of 200° C. and less.

16. Method according to claim 1,
wherein bonding comprises bonding the two substrates to each other by using a glass frit or a metal soldier bonding method at temperatures of 450° C. and less.

17. Method according to claim 1,
wherein the first and second substrates consist of at least one of the following or comprises at least one of the following materials:
silicone,
glass,
metal,
ceramics, or
plastic.

18. Electronic device with an integrated permanent magnet for providing a magnetic field, wherein the electronic device comprises:
a first substrate with a cavity extending from a first substrate surface towards the opposite second substrate surface,
wherein a mechanically firm porous permanent magnet generated by means of agglomerating loose powder comprising magnetic material is integrated within the cavity,
a second substrate, wherein at least one electronic component is arranged on a first substrate surface of the second substrate,
wherein the two substrates are bonded by means of a bonding layer attached between the two substrates, and
wherein the two substrates are aligned with respect to each other such that the permanent magnet integrated into the first substrate functionally interacts with the electronic component arranged on the second substrate and provides a magnetic field for the electronic component.
